(19) United States
(12) Patent Application Publication
(10) Pub. No.: US 2005/0159095 A1
(43) Pub. Date: Jul. 21, 2005

(54) Spacer for coin storage device, coin storage device, and coin processing device

(75) Inventors: Masaru Igusa, Sawa-gun (JP); Tetsuya Mashimo, Kodama-gun (JP)

Correspondence Address: BANNER & WITCOFF, 1001 G STREET N W, SUITE 1100, WASHINGTON, DC, 20001, US

(73) Assignee: Sanden Corporation, Isesaki-shi (JP)

(21) Appl. No.: 11/037,164

(22) Filed: Jan. 19, 2005

(30) Foreign Application Priority Data
Jan. 19, 2004 (JP) 2004-010883

(51) Int. Cl. G07D 9/06; G07F 1/04

(52) U.S. Cl. 453/61

(57) ABSTRACT

By inserting and installing a spacer in a storage passage for 500-yen coin of a storage device detached from a coin processing device, the shape of the storage passage for 500-yen coin of the storage device can be changed to a shape capable of storing 100-yen coins.

### BACKGROUND OF THE INVENTION

(i) Field of the Invention

The present invention relates to a spacer capable of being inserted in a storage passage of a coin storage device attached detachably to a coin processing device, a coin storage device which allows the spacer to attach to and detach from, and a coin processing device which is provided detachably with the coin storage device.

(ii) Description of the Related Art

In a coin-operated equipment such as a vending machine, there is provided a coin processing device having a function of identifying the authenticity and kinds of coins inserted to purchase commodity; a function of distributing genuine coins, storing them by the kind and returning false coins to a return port; and a function of paying coins corresponding to change from the stored coins to the return port.

As coin storing means, either a coin storage device having a single storage passage capable of storing specified coins in a stacked manner or a coin storage device having a plurality of storage passages has been used. The former coin storage device is prepared separately by the kind of coin, specifically, for 500-yen coin, 100-yen coin, 50-yen coin, and 10-yen coin, and is individually attached to or detached from the coin processing device. The latter coin storage device has a plurality of storage passages arranged separately by the kind of coin, specifically, for 500-yen coin, 100-yen coin, 50-yen coin, and 10-yen coin, and is attached to or detached from the coin processing device at one time.

The above-described coin storage device having the single storage passage can be attached and detached in the unit of the storage passage. Therefore, when a change in the storage passage is required, the already attached coin storage device can be exchanged to a coin storage device of another kind, for example, a coin storage device for 100-yen coin can be exchanged to a coin storage device for 10-yen coin.

However, this coin storage device having the single storage passage takes much time for installation work because desired coin storage devices need to be attached individually to the coin processing device. Also, all kinds of coin storage devices need to be prepared in a sufficient amount, so that the inventory management thereof is troublesome. Also, if the stock of coin storage devices to be used for exchange has run out, a desired change in storage passage cannot made in a timely manner.

On the other hand, the above-described coin storage device having the plural storage passages can be attached to and detached from the coin processing device in one operation. Therefore, unlike the coin storage device having the single storage passage, there is no bother in attaching desired coin storage devices individually.

However, this coin storage device having the plural storage passages cannot be attached and detached in the unit of the storage passage unlike the coin storage device having the single storage passage. Therefore, in the case where a change in the storage passage is required, for example, in the case where the storage passage for 100-yen coin is required to be changed to the storage passage for 10-yen coin when the coin storage device having a combination of five storage passages for 500-yen coin, 100-yen coin, 100-yen coin, 50-yen coin, and 10-yen coin has already been attached, the coin storage device need to be exchanged to another coin storage device having a combination of five storage passages for 500-yen coin, 100-yen coin, 50-yen coin, 10-yen coin, and 10-yen coin.

### SUMMARY OF THE INVENTION

An object of the present invention is to provide a spacer for a coin storage device, a coin storage device and a coin processing device capable of changing a storage passage in a timely manner without exchange of the coin storage device to another coin storage device even when a coin storage device having a single storage passage is used, or when a coin storage device having plural storage passages is used.

To achieve the above object, a spacer of the present invention, comprises: an ability to be inserted in a storage passage capable of storing specified coin in a stacked manner of a coin storage device of a coin processing device; and an ability to change an inner shape of the storage passage to a shape capable of storing different coin having a diameter smaller than that of the specified coin in a stacked manner in a state of being inserted in the storage passage.

According to this spacer, the inner shape of the storage passage can be changed to the shape capable of storing different coin having the diameter smaller than that of the specified coin in a stacked manner by inserting the spacer in the storage passage. Thereby, the storage passage can be changed in a timely manner without exchange of the coin storage device to another coin storage device.

Also, a coin storage device of the present invention, comprises: a storage passage capable of storing specified coin in a stacked manner; and an ability to be attached to and detached from a coin processing device; wherein the storage passage allows a spacer to be inserted, the spacer is able to change an inner shape of the storage passage to a shape capable of storing different coin having a diameter smaller than that of the specified coin in a stacked manner.

According to this coin storage device, by inserting the spacer in the storage passage, the inner shape of the storage passage can be changed to the shape capable of storing different coin having the diameter smaller than that of the specified coin in a stacked manner. Thereby, the storage passage can be changed in a timely manner without exchange of the coin storage device to another coin storage device.

Further, a coin processing device of the present invention, comprises: a coin storage device having an ability to be attached to and detached from the coin processing device, the coin storage device having a storage passage capable of storing specified coin in a stacked manner, wherein the storage passage of the coin storage device allows a spacer to be inserted, the spacer is able to change an inner shape of the storage passage to a shape capable of storing different coin having a diameter smaller than that of the specified coin in a stacked manner.

According to this coin processing device, by inserting the spacer in the storage passage of the coin storage device, the inner shape of the storage passage can be changed to the shape capable of storing different coin having the diameter smaller than that of the specified coin in a stacked manner. Thereby, the storage passage can be changed in a timely manner without exchange of the coin storage device to another coin storage device.

The above and other objects, features, and advantages of the present invention will become apparent from the following description and accompanying drawings.

### BRIEF DESCRIPTION OF THE DRAWINGS

FIG. 1(A) is a front view of a coin processing device in which a coin storage device having plural storage passages is provided detachably;

FIG. 1(B) is a front view showing a state in which the coin storage device is detached from the coin processing device shown in FIG. 1(A);

FIG. 2(A) is a front view of the coin storage device shown in FIG. 1(A);

FIG. 2(B) is a top view of FIG. 2(A);

FIG. 2(C) is a view showing a state in which four kinds of coins are stored in the coin storage device shown in FIG. 1(A);

FIG. 3 is a front view of the coin storage device and the spacer shown in FIG. 1(A);

FIGS. 4(A) to 4(C) are explanatory views for illustrating an installation of the spacer shown in FIG. 3;

FIG. 5 is a view showing a state in which the spacer shown in FIG. 3 is installed to the coin storage device shown in FIG. 1(A);

FIG. 6(A) is a top view of a spacer showing another shape example of the spacer shown in FIG. 3;

FIG. 6(B) is a view showing a state in which the spacer shown in FIG. 6(A) is installed in the coin storage device shown in FIG. 1(A);

FIG. 7(A) is a top view of a spacer showing still another shape example of the spacer shown in FIG. 3;

FIG. 7(B) is a view showing a state in which the spacer shown in FIG. 7(A) is installed in the coin storage device shown in FIG. 1(A);

FIG. 8(A) is a sectional view of a principal portion of a coin processing device in which a plurality of coin storage devices each having a single storage passage are provided detachably; and

FIG. 8(B) is a view showing a state in which the spacer shown in FIG. 3 is installed in the coin storage device shown in FIG. 8(A).

### DESCRIPTION OF THE PREFERRED EMBODIMENTS

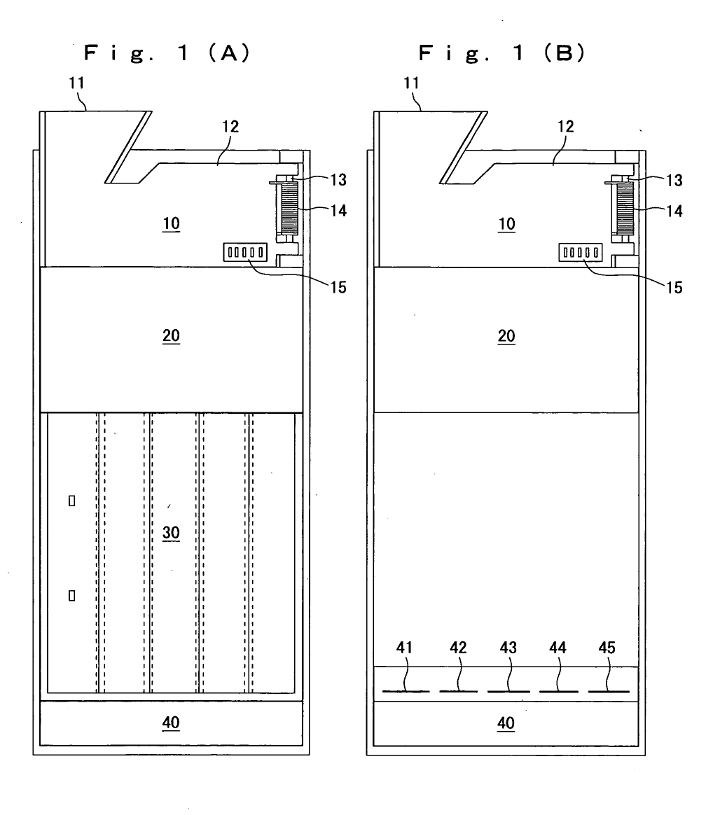

FIGS. 1 to 5 show an embodiment in which the present invention is applied to a coin processing device provided detachably with a coin storage device having plural storage passages.

A coin processing device shown in FIGS. 1(A) and 1(B) has a coin identification section 10 provided at an upper part of the coin processing device, a coin distribution section 20 provided on the lower side of the coin identification section 10, a coin storage device 30 provided detachably on the lower side of the coin distribution section 20, and a coin payment section 40 provided on the lower side of the coin storage device 30.

The coin identification section 10 is provided with a port 11 for receiving a fed coin, a detection passage (not shown) for guiding the received coin in a predetermined direction, and a sensor (not shown) for detecting and identifying the authenticity and kinds of coins based on a change in magnetic field in a process in which the coin passes through the detection passage. The coin identification section 10 has a cover 12 for removing a coin getting stuck in the detection passage. This cover 12 is configured so that a shaft provided at one end thereof is pivotally supported by a device housing, and the cover 12 is urged in the closing direction by a coil spring 14, so that the cover 12 is normally closed. Also, on the cover 12, dip switches 15 for setting the distribution direction of coin by means of the coin distribution section 20 are provided so as to correspond to a plurality of storage passages 31 to 35, or so as to correspond to only a predetermined storage passage, for example, the coin storage passage 31 for 500-yen coin.

The coin distribution section 20 is provided with a plurality of distribution passages leading to upper end openings of the storage passages 31 to 35, and a return passage (both not shown), a plurality of distribution plates (not shown) for guiding a coin sent from the coin identification section 10 to a predetermined distribution passage, and solenoids (not shown) for driving the distribution plates. The solenoids for driving the distribution plates are operated by a distribution signal sent from a controller for controlling the coin processing device based on a detection signal of the coin identification section 10 and a setting signal of the dip switches 15.

That is to say, the coin distribution section 20 changes over the distribution passages by driving the distribution plates appropriately so that, when the coin received by the coin identification section 10 is a genuine coin, the coin is stored in a predetermined storage passage 31 to 35. Also, when the coin received by the coin identification section 10 is a false coin, the coin distribution section 20 drives the distribution plates appropriately so as to guide the false coin to the return passage.

The coin storage device 30 is formed integrally of a transparent or translucent plastics. As shown in FIGS. 2(A) to 2(C), the coin storage device 30 is provided, in a state of being arranged in a row, with the storage passages having a circular cross section, the top end of which is open, specifically with the storage passage 31 capable of storing 500-yen coins in a stacked manner, the storage passage 32 capable of storing 50-yen coins in a stacked manner, the storage passage 33 capable of storing 10-yen coins in a stacked manner, and two storage passages 34 and 35 capable of storing 100-yen coins in a stacked manner. Also, on one side of the lower end of each of the storage passages 31 to 35, there is provided a window hole (not shown) which enables the insertion of a paying plate described later and the draw-out of the coin at the lowest position by means of the paying plate.

This coin storage device 30 can be attached to the coin processing device by being inserted in a hollow provided on the lower side of the coin distribution section 20, and is prevented from coming off by engaging an engagement lever provided on the front side of the coin storage device 30 with the device housing. When the coin storage device 30 is detached from the coin processing device, it is necessary only that the engagement lever is operated to disengage the coin storage device 30 from the device housing, and then the coin storage device 30 is drawn forward. That is, this coin storage device 30 can be attached to and detached from the coin processing device at a time.

The coin payment section 40 is provided with five paying plates 41 to 45 capable of being inserted in the window holes of the storage passages 31 to 35 respectively, and solenoids (not shown) for each driving the paying plates 41 to 45 so as to advance and retract them.

The solenoids for driving the paying plates are operated based on a payment signal sent from the controller for controlling the coin processing device. That is, the coin payment section 40 pays coins by appropriately advancing and retracting five paying plates 41 to 45 so that, when the change must be given, coins corresponding to the change are send out to the return port.

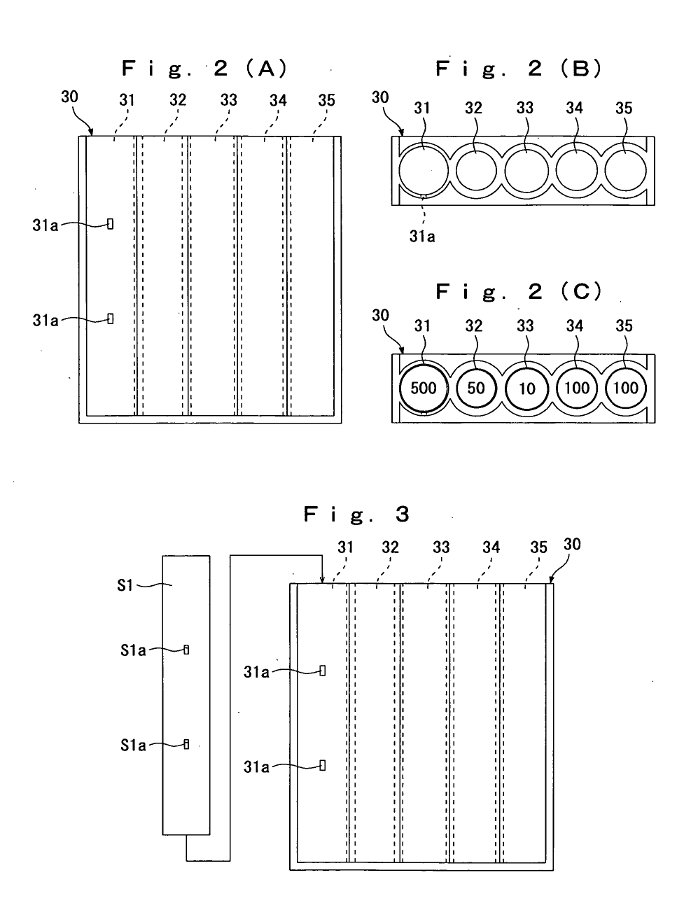

In the storage passage 31 for 500-yen coin of the coin storage device 30, as shown in FIGS. 2(A) to 2(C) and FIG. 3, two engaged portions, specifically rectangular elongated holes 31a, for detachably mounting a spacer S1 described later, are provided at an interval in the vertical direction.

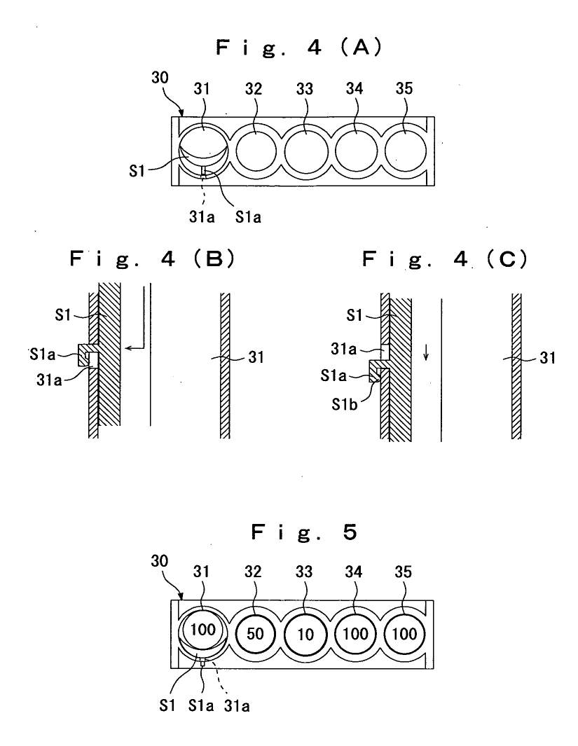

The spacer S1 shown in the figure is used to change the shape of the storage passage 31 for 500-yen coin to a shape capable of storing 100-yen coins, the diameter of which is smaller than that of a 500-yen coin, in a stacked manner. The spacer S1 is formed of a transparent or translucent plastics. As shown in FIG. 3 and FIGS. 4(A) to 4(C), the spacer S1 has a C-shaped cross section having an outside surface curvature following the inside surface of the storage passage 31 for 500-yen coin, and the vertical dimension thereof approximately coincides with the vertical dimension of the coin storage passage 31 for 500-yen coin. Also, the inside surface curvature of the spacer S1 is larger than the diameter of the 100-yen coin, and the angle between the left end and the right end of outside surface, as viewed from the top side, is smaller than 180 degrees. Further, on the outside surface of the spacer S1, two engaging portions corresponding to the rectangular elongated holes 31a, specifically L-shaped hooks S1a, are provided at an interval in the vertical direction. The vertical dimension and the transverse dimension of the L-shaped hook S1a are slightly smaller than the vertical dimension and the transverse dimension of the rectangular elongated hole 31a. Also, a gap between a semispherical convex portion S1b provided on the inside of the end portion of the L-shaped hook S1a and the outside surface of the spacer S1 is slightly smaller than the thickness of an outer wall of the storage passage 31 for 500-yen coin.

When the shape of the coin storage passage 31 for 500-yen coin of the storage device 30 is changed to a shape capable of storing 100-yen coins by using the spacer S1, after the storage device 30 is detached from the coin processing device, as shown in FIGS. 4(A) to 4(C), the spacer S1 is inserted downward from an upper end opening of the storage passage 31 for 500-yen coin, and then the two L-shaped hooks S1a are inserted into the rectangular elongated holes 31a from the inside and are projected outward, and then the spacer S1 is pushed downward to hold the outer wall of the storage passage 31 for 500-yen coin between the semispherical convex portions S1b of the L-shaped hooks S1a and the outside surface of the spacer S1, and then the storage device 30 in which the spacer S1 was installed is attached to the coin processing device.

Since the inside surface curvature of the spacer S1 is larger than the diameter of the 100-yen coin, and the angle between the left end and the right end of outside surface, as viewed from the top side, is smaller than 180 degrees, the cross-sectional shape of the storage passage 31 in which the spacer S1 was inserted is not circular but close to an ellipse as shown in FIG. 5. However, a gap between the inside surface of the spacer S1 and the inside surface of the storage passage 31 for 500-yen coin which faces to the inside surface of the spacer S1 is slightly larger than the diameter of the 100-yen coin, so that even if the cross-sectional shape of the storage passage 31 is the above-described shape, hindrance to the storage of 100-yen coins in a stacked manner is not caused.

In order to use the storage passage 31 for 500-yen coin as a storage passage for 100-yen coin after the storage device 30 in which the spacer S1 was installed is attached to the coin processing device, the passage setting is changed by operating the dip switches 15 of the coin identification section 10 so that the storage passage 31 for 500-yen coin is identified as a storage passage for 100-yen coin. By this change of passage setting, the storage passage 31 for 500-yen coin is identified as a storage passage for 100-yen coin, and resultantly the storage device 30 is used as a storage device having the storage passage 32 for 50-yen coin, the storage passage 33 for 10-yen coin, and three storage passages 31, 34, and 35 for 100-yen coin.

In order to return the storage passage 31 for 100-yen coin to a storage passage for 500-yen coin, after the storage device 30 is detached from the coin processing device, the spacer S1 is removed by reversing the above procedure, and the storage device 30 from which the spacer S1 was removed is attached to the coin processing device. Also, the dip switches 15 are operated to return the passage setting to the original state.

In the above explanation, there has been shown the spacer S1 such that the storage passage 31 in which the spacer S1 was inserted has the cross-sectional shape close to an ellipse. However, if a spacer S2 as shown in FIGS. 6(A) and 6(B) is used, the storage passage 31 in which the spacer S1 was inserted can change the cross-sectional shape to a circular slightly larger than the diameter of a 100-yen coin.

The spacer S2 shown in FIGS. 6(A) and 6(B) is formed of a transparent or translucent plastics. The spacer S2 has a C-shaped cross section having an outside surface curvature following the inside surface of the storage passage 31 for 500-yen coin, and the vertical dimension thereof approximately coincides with the vertical dimension of the coin storage passage 31 for 500-yen coin. Also, the inside surface curvature of the spacer S2 is close to the diameter of a 100-yen coin, and the angle between the left end and the right end of outside surface, as viewed from the top side, exceeds 180 degrees. An L-shaped hook S2a is the same as the L-shaped hook S1a of the spacer S1.

When the shape of the coin storage passage 31 for 500-yen coin of the storage device 30 is changed to a shape capable of storing 100-yen coins by using the spacer S2, after the storage device 30 is detached from the coin processing device, the spacer S2 is inserted downward from the upper end opening of the storage passage 31 for 500-yen coin after both end portions of the spacer S2 are deflected inward, and then the two L-shaped hooks S2a are inserted into the rectangular elongated holes 31a from the inside and are projected outward, and then the spacer S2 is pushed downward to hold the outer wall of the storage passage 31 for 500-yen coin between the semispherical convex portions of the L-shaped hooks S2a and the outside surface of the spacer S2, and then the storage device 30 in which the spacer S2 was installed is attached to the coin processing device. The both end portions deflected inward at the time of insertion is restored by their own elasticity, so that the outside surface of the spacer S2 was inserted follows the inside surface of the storage passage 31 for 500-yen coin.

Since the inside surface curvature of the spacer S2 is close to the diameter of a 100-yen coin, the angle between the left end and the right end of outside surface, as viewed from the top side, exceeds 180 degrees, and the cross-sectional shape of the storage passage 31 in which the spacer S2 was inserted is a circular as shown in FIG. 6(B), 100-yen coins can be stored in this passage having a circular cross section in a stacked manner.

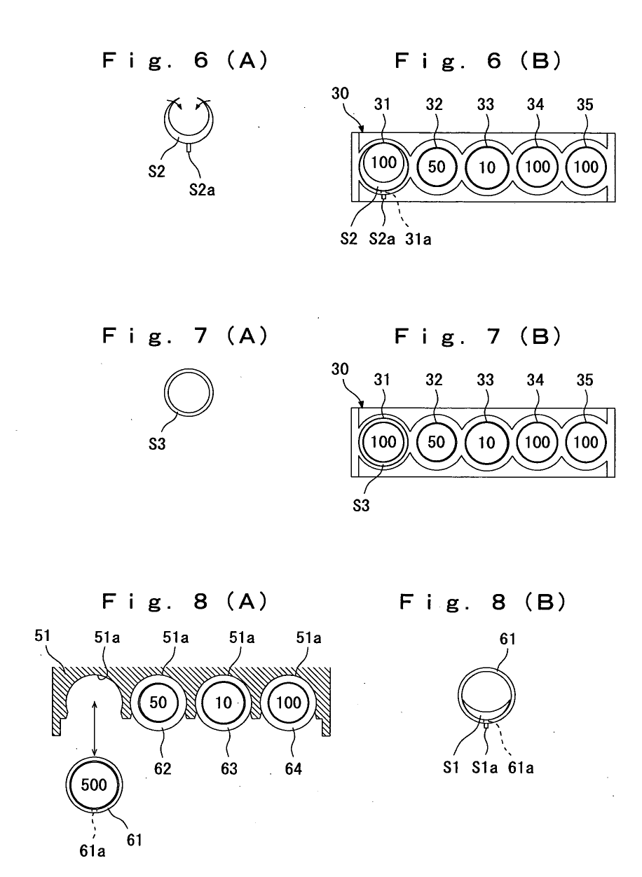

Also, in the above explanation, there have been shown the spacers S1 and S2 each having a C-shaped cross section. However, a spacer S3 having a cylindrical shape as shown in FIGS. 7(A) and 7(B) can also be used.

The spacer S3 is made of a transparent or translucent plastic, and is formed in a cylindrical shape. The outside diameter of the spacer 3 is slightly smaller than the inside diameter of the storage passage 31 for 500-yen coin and the inside diameter thereof is slightly larger than the outside diameter of a 100-yen coin, and the vertical dimension thereof approximately coincides with the vertical dimension of the coin storage passage 31 for 500-yen coin. The spacer S3 has no L-shaped hook unlike the spacers S1 and S2, so that the rectangular elongated holes 31a may be eliminated from the coin storage passage 31 for 500-yen coin.

When the shape of the coin storage passage 31 for 500-yen coin of the storage device 30 is changed to a shape capable of storing 100-yen coins by using the spacer S3, after the storage device 30 is detached from the coin processing device, the spacer S3 is inserted downward from the upper end opening of the coin storage passage 31 for 500-yen coin and is installed to the passage 31, and then the storage device 30 in which the spacer S3 was installed is attached to the coin processing device.

Since the inside diameter of the spacer S3 matches the diameter of a 100-yen coin, and the cross-sectional shape of the storage device 30 in which the spacer S3 was installed is circular as shown in FIG. 7(B), 100-yen coins can be stored in this passage 31 having a circular cross-sectional shape in a stacked manner.

Further, in the above explanation, an example has been shown in which the present invention is applied to the coin processing device provided detachably with the coin storage device having the plural storage passages. However, the present invention can also be applied to a coin processing device having a single storage passage, which is provided detachably with a plurality of coin storage devices.

FIGS. 8(A) and 8(B) show one example in which the present invention is applied to a coin processing device having the single storage passage. In the figures, reference numeral 51 denotes a holder provided in the coin processing device, 61 denotes a coin storage device for 500-yen coin, 62 denotes a coin storage device for 50-yen coin, 63 denotes a coin storage device for 10-yen coin, and 64 denotes a coin storage device for 100-yen coin.

The coin storage devices 61 to 64 each have a single storage passage having a circular cross section, the upper end of which is open, so that coins corresponding to the inside diameter of the each storage passage can be stored in a stacked manner. Also, on one side of the lower end of each of the storage passages 61 to 64, there is provided a window hole (not shown) which enables the insertion of a paying plate of a coin payment portion and the draw-out of the coin at the lowest position by means of the paying plate. The coin storage devices 61 to 64 have the same outside diameter, and the holder 51 is provided with four mounting portions 51a capable of detachably attaching the coin storage devices 61 to 64 respectively.

In the coin storage device 61 for 500-yen coin, two engaged portions, specifically rectangular elongated holes 61a like the elongated holes 31a, for detachably mounting the spacer S1 are provided at an interval in the vertical direction.

When the shape of the coin storage passage of the coin storage device 61 for 500-yen coin is changed to a shape capable of storing 100-yen coins by using the spacer S1, after the coin storage device 61 for 500-yen coin is detached from the coin processing device, the spacer S1 is inserted downward from an upper end opening of the storage passage of the coin storage device 61 for 500-yen coin, and then the two L-shaped hooks S1a are inserted into the rectangular elongated holes 61a from the inside and are projected outward, and the spacer S1 is pushed downward to hold the outer wall of the coin storage device 61 for 500-yen coin between the semispherical convex portions of the L-shaped hooks S1a and the outside surface of the spacer S1, and then the coin, storage device 61 in which the spacer S1 was installed is attached to the coin processing device. Needless to say, in place of the spacer S1, the spacer S2 or the spacer S3 can also be used.

In this case as well, in order to use the storage passage of the coin storage device 61 for 500-yen coin as a storage passage for 100-yen coin after the coin storage device 61 for 500-yen coin in which the spacer was installed is attached to the coin processing device, the passage setting is changed by operating the dip switches 15 of the coin identification section 10 so that the coin storage device 61 for 500-yen coin is identified as a coin storage device for 100-yen coin.

Further, in the above explanation, for the coin storage device having the plural storage passages, the case where the storage passage 31 for 500-yen coin is used as a storage passage for 100-yen coin was shown as an example, and for the coin storage device having the single storage passage, the coin storage device 61 for 500-yen coin is used as a coin storage device for 100-yen coin. However, by changing the thickness etc. of the spacers S1 to S3, the storage passage for 500-yen coin can be changed to a storage passage for 50-yen or 10-yen coin, the storage passage for 10-yen coin can be changed to a storage passage for 50-yen or 100-yen coin, or the storage passage for 100-yen coin can be changed to a storage passage for 50-yen coin. In summary, a storage passage capable of storing specified coins can be changed appropriately to a storage passage for different coins having a smaller diameter.

As described above, in the case where the coin storage device having the single storage passage type is used, or even in the case where the coin storage device having the plural storage passages is used, there can be provided the spacer for the coin storage device, the coin storage device, and the coin processing device capable of changing the storage passage in a timely manner without exchange of the coin storage device to another coin storage device,

Especially in the case where the coin storage device having the plural storage passages is used, the storage passage can be changed by the spacer only without the preparation of another coin storage device. Moreover, since the coin storage device can be attached to and detached from the coin processing device, the coin storage device of this type is advantageous in terms of cost and work as compared to the coin storage device having the single storage passage.

In the above description, an example in which Japanese coins are used has been shown. However, it is a matter of course that the present invention can be applied to the case where coins of countries other than Japan are used, and in this case as well, the same operation and effects as those described above can be achieved.

The preferred embodiments described in this specification are typical and not restrictive. The scope of the present invention is set forth in the claims hereto appended, and all modifications in the meaning of the claims are included in the present invention.

1. A spacer for a coin storage device, comprising:
an ability to be inserted in a storage passage capable of storing specified coin in a stacked manner of a coin storage device of a coin processing device; and
an ability to change an inner shape of the storage passage to a shape capable of storing different coin having a diameter smaller than that of the specified coin in a stacked manner in a state of being inserted in the storage passage.

2. The spacer according to claim 1, wherein the spacer has a C-shaped cross section having an outside surface curvature following an inside surface of the storage passage having a circular cross section of the coin storage device.

3. The spacer according to claim 1, wherein the spacer is provided with an engaging portion capable of being attached to and detached from an engaged portion provided on the storage passage when being inserted in the storage passage of the coin storage device.

4. The spacer according to claim 3, wherein the engaged portion of the storage passage includes an elongated hole, and the engaging portion includes an L-shaped hook which is inserted and engaged with the engaged portion of the storage passage.

5. A coin storage device, comprising:
a storage passage capable of storing specified coin in a stacked manner; and
an ability to be attached to and detached from a coin processing device;
wherein the storage passage allows a spacer to be inserted, the spacer is able to change an inner shape of the storage passage to a shape capable of storing different coin having a diameter smaller than that of the specified coin in a stacked manner.

6. The coin storage device according to claim 5, wherein the storage passage has a circular cross section which allows an insertion of the spacer which has a C-shaped cross section having an outside surface curvature following an inside surface of the storage passage.

7. The coin storage device according to claim 5, wherein the storage passage has an engaged portion which can be engaged with and disengaged from an engaging portion provided on the spacer inserted in the storage passage.

8. The coin storage device according to claim 7, wherein the engaged portion of the storage passage includes an elongated hole, and the engaging portion of the spacer includes an L-shaped hook which is inserted and engaged with the engaged portion of the storage passage.

9. A coin processing device, comprising:
a coin storage device having an ability to be attached to and detached from the coin processing device, the coin storage device having a storage passage capable of storing specified coin in a stacked manner,
wherein the storage passage of the coin storage device allows a spacer to be inserted, the spacer is able to change an inner shape of the storage passage to a shape capable of storing different coin having a diameter smaller than that of the specified coin in a stacked manner.

10. The coin processing device according to claim 9, wherein the storage passage of the coin storage device has a circular cross section which allows an insertion of the spacer which has a C-shaped cross section having an outside surface curvature following an inside surface of the storage passage.

11. The coin processing device according to claim 9, wherein the storage passage of the coin storage device has an engaged portion which can be engaged with and disengaged from an engaging portion provided on the spacer inserted in the storage passage.

12. The coin processing device according to claim 11, wherein the engaged portion of the storage passage includes an elongated hole, and the engaging portion of the spacer includes an L-shaped hook which is inserted and engaged with the engaged portion of the storage passage.
